(19) United States
(12) Patent Application Publication
(10) Pub. No.: US 2026/0181688 A1
(43) Pub. Date: Jun. 25, 2026

(54) SCHEDULING WITH SFO ESTIMATION FOR AMBIENT IOT

(71) Applicant: InterDigital Patent Holdings, Inc., Wilmington, DE (US)

(72) Inventors: Erdem Bala, East Meadow, NY (US); Remun Koirala, London (GB); Paul Marinier, Brossard (CA); Martino Freda, Laval (CA); Kevin Wanuga, Souderton, PA (US); Aata El Hamss, Laval (CA); Moon IL Lee, Melville, NY (US); Jongwoo Hong, New York, NY (US)

(73) Assignee: InterDigital Patent Holdings, Inc., Wilmington, DE (US)

(21) Appl. No.: 18/990,084

(22) Filed: Dec. 20, 2024

(51) Int. Cl. H04W 74/0816; H04W 74/04; H04W 74/08

(52) U.S. Cl. CPC H04W 74/0816; H04W 74/04; H04W 74/0866

(57) ABSTRACT

An AIoT reader may be configured to transmit measurement monitoring window configuration information. The measurement monitoring window configuration information may comprise an indication of a time duration and a gap duration. The reader may be configured to transmit at least one measurement message during a measurement monitoring window. The reader may be configured to transmit a device to reader (D2R) configuration message. The D2R configuration message may comprise at least one measurement parameter. The reader may be configured to transmit a D2R scheduling message. The D2R scheduling message may comprise at least one scheduling parameter based on the at least one measurement parameter. The measurement monitoring window configuration information may comprise an indication of a start time of the measurement monitoring window. The D2R configuration message may be a paging message. The at least one measurement parameter may be associated with a parameter of the at least one measurement message.

### BACKGROUND

3GPP RAN has started studying ambient Internet of Things (IoT) (AIOT). The devices that are in the scope of the study may have power consumption of about 1 μW to a few hundreds of μW. The devices may transmit using backscattering.

In backscattering, a device reflects a received radio frequency (RF) signal after modulating the signal using a baseband signal. Baseband physical layer processing may use line codes for digital baseband modulation. In a line code, digital bits are encoded into one or a sequence of pulses. For example, bit 1 may be encoded as a pulse with voltage level +A and bit 0 may be encoded as a pulse of voltage level 0.A=1 may be assumed without loss of generality. In another example, bit 1 may be encoded as a pulse with voltage level +A and bit 0 may be encoded as a pulse of voltage level-A. In another example, bit 1 may be encoded as a half-pulse with voltage level 0, or—A, followed by a half-pulse with voltage level A and bit 0 may be encoded as a half-pulse with voltage level +A followed by a half-pulse with voltage level 0, or—A. This last encoding scheme is known as Manchester encoding.

### SUMMARY

An AIoT reader may be configured to transmit measurement monitoring window configuration information. The measurement monitoring window configuration information may comprise an indication of a time duration and a gap duration. The reader may be configured to transmit at least one measurement message during a measurement monitoring window. The reader may be configured to transmit a device to reader (D2R) configuration message. The D2R configuration message may comprise at least one measurement parameter. The reader may be configured to transmit a D2R scheduling message. The D2R scheduling message may comprise at least one scheduling parameter based on the at least one measurement parameter. The measurement monitoring window configuration information may comprise an indication of a start time of the measurement monitoring window. The D2R configuration message may be a paging message. The reader may determine the at least one measurement parameter based on a sampling frequency offset (SFO). The at least one measurement parameter may be associated with a parameter of the at least one measurement message. The parameter of the at least one measurement message may be a number of measurement messages transmitted during the measurement monitoring window. The at least one measurement parameter may indicate a value or a range of values. The at least one measurement parameter may comprise at least one of: a number of chips of a measurement signal, a number of falling and/or rising edges of a measurement signal, a received power, a received energy, or a number of messages detected during the measurement monitoring window. The at least one scheduling parameter may comprise a starting time of a D2R transmission and a time gap between an end of a first D2R transmission and a start time of a second D2R transmission. The at least one measurement message may comprise a signal comprising a plurality of chips. The reader may be a wireless transmit/receive unit (WTRU) or a gNB. The AIoT reader may communicate with an AIoT device.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 shows an example random access procedure in Ambient IoT (AIOT);

FIG. 3 shows an example inventory procedure using RFID;

FIG. 4 shows an example of backscattering modulation;

FIG. 5 shows an example of devices monitoring reader to device (R2D) transmission;

FIG. 6 shows an example of devices monitoring reader to device (R2D) transmission;

FIG. 7a shows an example of device to reader (D2R) scheduling with a first (longer) time gap;

FIG. 7a shows an example of device to reader (D2R) scheduling with a second (shorter) time gap;

FIG. 8 shows an example procedure for use in a reader; and

FIG. 9 shows an example procedure for use in a device.

### DETAILED DESCRIPTION

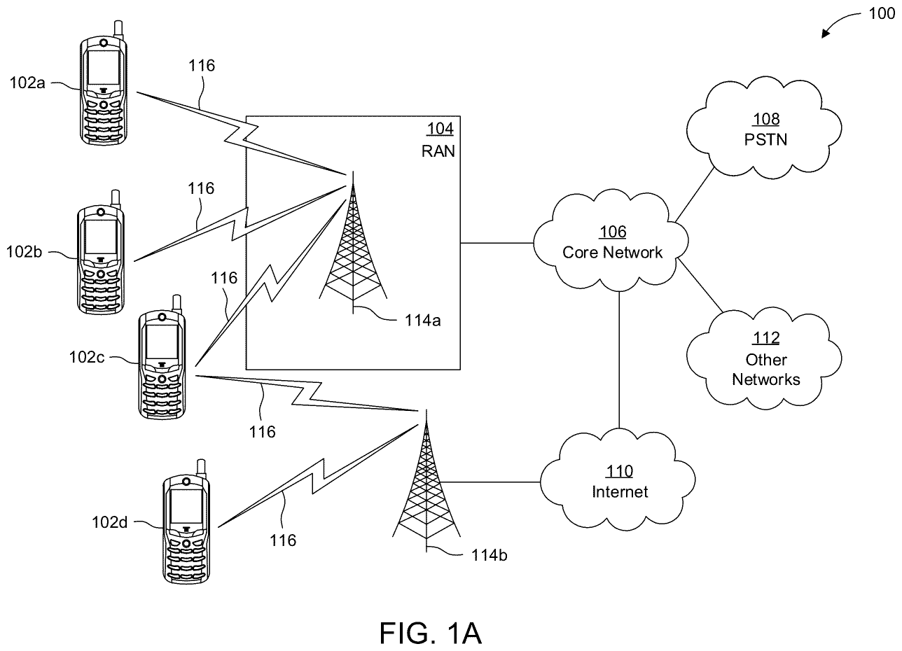

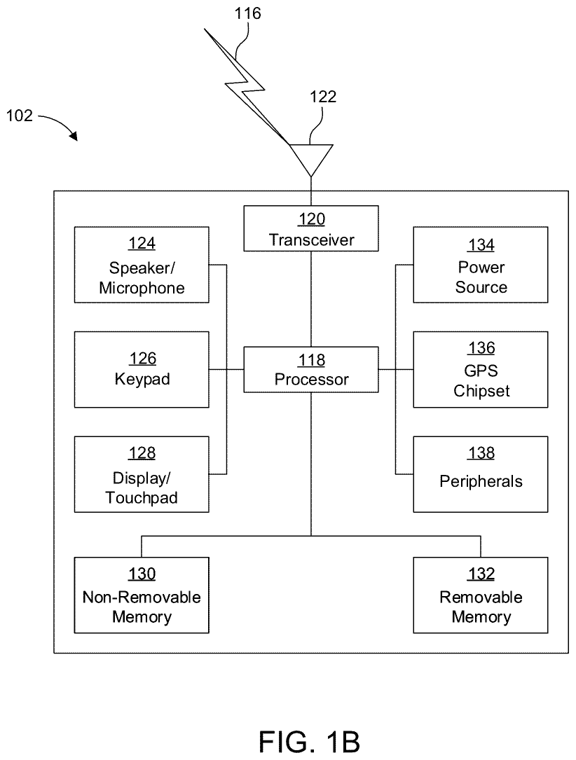

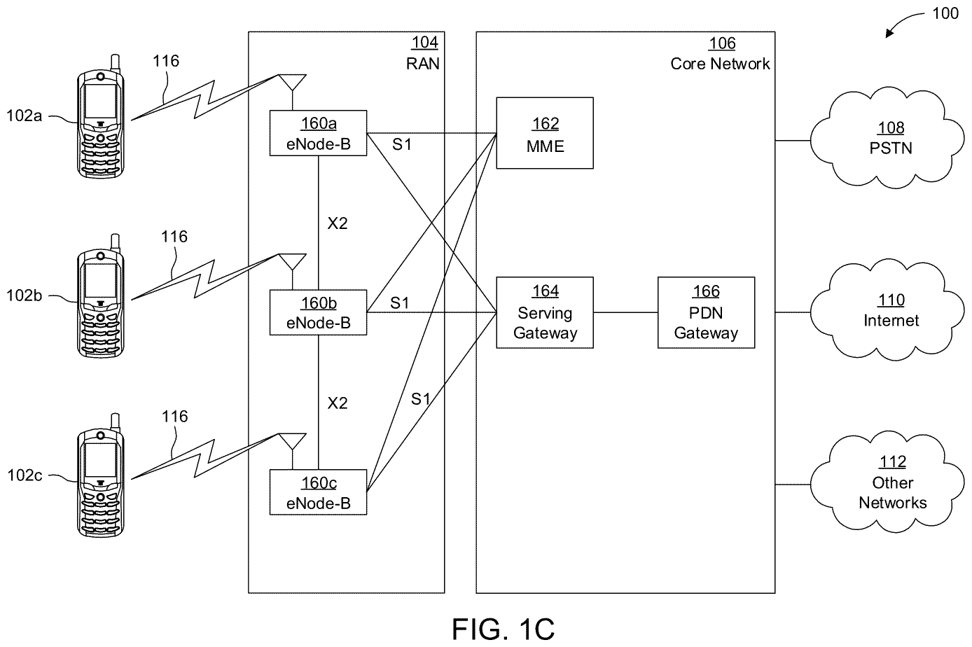

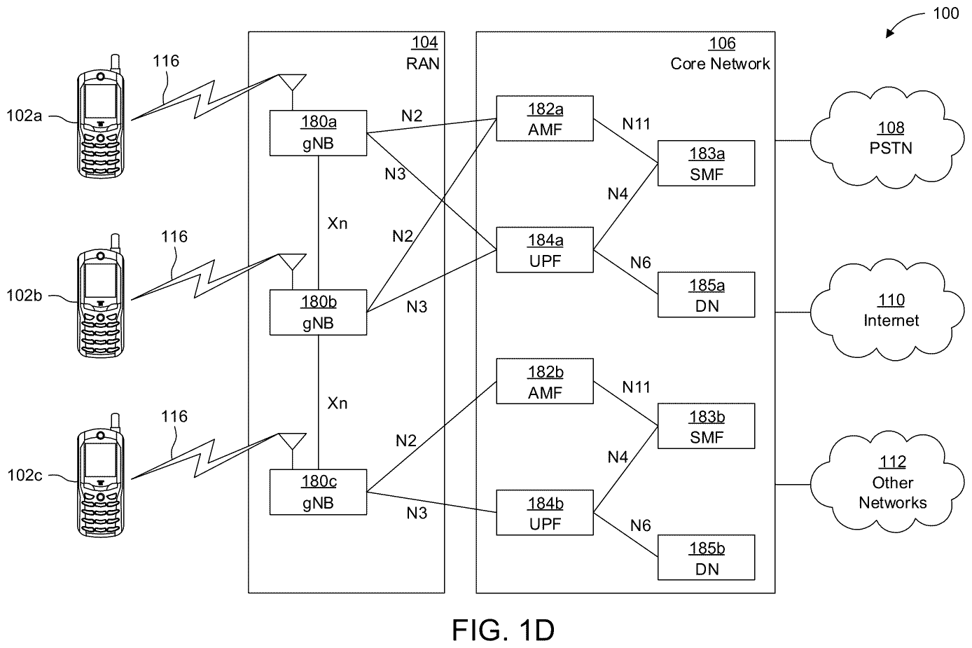

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

An IoT device may use backscatter modulation to transmit data to a receiver. In backscattering, a device does not generate an RF carrier but receives it from an external source and reflects the received RF signal. The baseband signal may be modulated on the reflected RF carrier. This may be achieved by using an impedance mismatch concept. An antenna impedance may be connected to a load impedance at the device. By changing the reflection coefficient (e.g. by adjusting the load impedance) over time, the amplitude or frequency of the reflected signal may be changed. For example, ON-OFF keying modulation may be achieved by using a non-reflecting state/OFF signal or a reflecting state/ON signal. The RFID specification is based on backscatter communications wherein RFID tags switch the reflection coefficient between two states based on the data being sent. Amplitude-shift keying (ASK) and phase-shift keying (PSK) are supported by the RFID tags.

In some embodiments, digital bits may be encoded as a sequence of pulses without using a line code. For example, bit 1 may be encoded as a square wave over a finite duration with a first periodicity and bit 0 may be encoded as a square wave over a finite duration with a second periodicity. A baseband processing method that is used in RFID is subcarrier modulation. In this method, a subcarrier signal, that is usually a square wave, is used to multiply the line coded signal. The multiplication may be achieved by a XNOR operation, if voltage levels are unipolar, or scalar multiplication, if voltage levels are polar. The resulting signal may then be transmitted using backscatter modulation Except for the RF carrier signal, all signals discussed may be considered baseband signals.

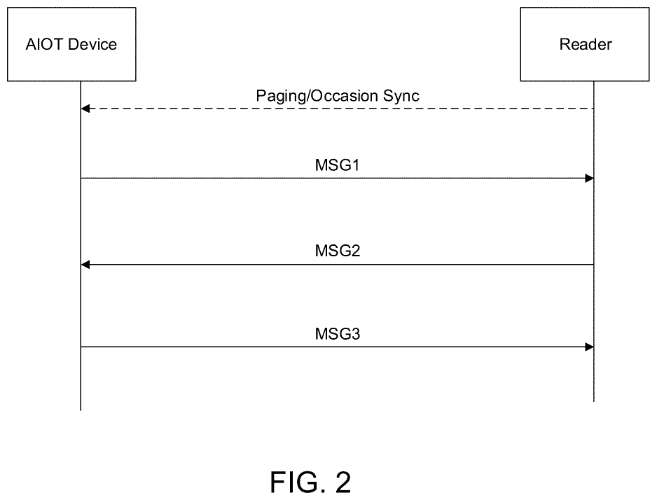

FIG. 2 shows an example random access procedure in Ambient IoT (AIOT). Random access has been agreed in 3GPP for AIOT after a device determines its transmission occasion 210. The device may transmit a random identification (ID) in MSG 1 220. The reader may respond with (echo back) the random ID in MSG 2 230.The device may send its device ID and/or application layer data in MSG 3 240.

The reader, which may be referred to as an interrogator, may be a gNB, a WTRU, or another wireless device. The embodiments described herein may not be limited to IoT devices performing backscattering. They may also be applicable to IoT devices that can generate an RF carrier, that does not need an external carrier, and other wireless devices.

The reader may use an On-Off Keying (OOK) modulated signal to transmit a baseband signal to a device. The baseband signal may be a line encoded signal. For 3GPP Ambient IoT, it has been agreed that an OFDM-based OOK waveform with subcarrier spacing of 15 kHz may be used studied for Reader-to-Device (R2D) transmission. Device-to-Reader transmission may be referred to as D2R.

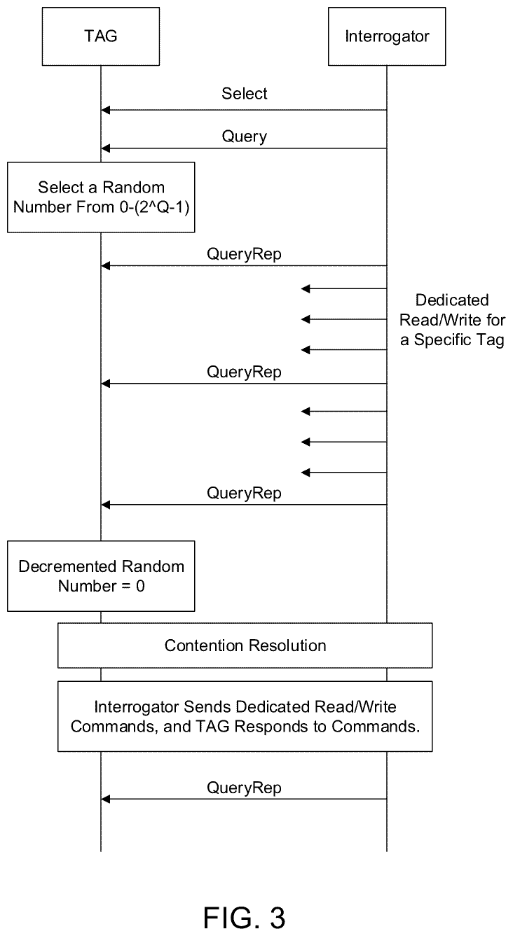

RFID may be used for applications of asset identification. FIG. 3 shows a high-level summary of an inventory procedure using RFID. In an RFID inventory procedure, an interrogator (reader) sends a Query message to energize all or a subset of TAGs. Following the Query message, a TAG selects a random number from 0-2\hat{ }Q-1 and loads its memory with that number. At each transmission of a QueryRep, the TAG decrements its counter until the counter reaches 0. When the counter reaches 0, the TAG initiates a contention resolution procedure which comprises transmitting its device identification (ID) in the uplink and waiting for confirmation of the device ID in the downlink, to address possible collisions between multiple devices selecting the same random number. For a device that has passed the contention resolution, the interrogator may send multiple read/write commands, to which the TAG may respond.

A Sampling Frequency Offset (SFO) may refer to a mismatch between an actual sampling frequency of a device's receiver and an intended sampling frequency. This offset may occur due to, for example, hardware imperfections, oscillator instability, or environmental factors like temperature changes. In AIOT systems, where low-cost and energy-efficient devices operate passively or with minimal power, SFO may significantly impact communication reliability and performance. SFO may be as high as 10% for IoT devices. Due to the high SFO, a device may make errors in measuring a chip duration. This may impact decoding and time keeping in the R2D channel and link frequency generation and time keeping in the D2R channel.

There may be an impact on FDMA due to SFO. In D2R transmission, several devices may transmit simultaneously using FDMA where FDMA may be achieved by changing the chip duration. When the chip duration is not correct, the spectrum of the signal deviates from the desired spectrum and signals from devices may interfere with each other. A simple solution is to have a buffer frequency between adjacent subbands to accommodate for a worst case SFO. However, this reduces efficiency.

There may be Impact on TDMA due to SFO. Devices may use TDMA, for example during Msg1 transmission. Due to errors in duration measurement, signals from devices may overlap and interfere with each other. For example, a device may start transmitting before a previous device finishes its transmission. To accommodate for a worst case SFO, a time gap may be place between consecutive Msg1 time resources. However, the more Msg1 resources there are, the larger the gap should be, which reduces system efficiency.

A reader may transmit a R2D message comprising at least a resource allocation wherein the resource allocation comprises at least a gap duration and a monitoring interval / window duration. The reader may transmit a number of (k) messages in k resources within the monitoring interval. Alternatively, the reader may transmit a signal comprising a number of (n) chips within the monitoring window. The time durations may be a function of the R2D chip duration.

A device may receive the R2D message and measure the indicated gap duration to find a start of the monitoring interval. However, due to SFO, the gap may be measured incorrectly and the monitoring window location in time may shift to an earlier or later time. Depending on how many of the k messages, or n chips, a device detects or measures, SFO may be implicitly determined.

The reader may transmit a R2D message (e.g., a paging message) to configure a D2R transmission. At least one parameter of the D2R configuration may be associated with a parameter (e.g., k or n) of the signal transmitted in the monitoring window. For example, the parameter may be an integer between 1-to-k (or 1-to-n). Devices that have measured the number of messages/chips indicated with the parameter may join the associated inventory round.

The reader may transmit a resource allocation for the D2R transmission. The resource allocation may be related to the indicated parameter. For example, the gap frequency and/or the gap interval may be determined by a device based on the indicated parameter.

In this disclosure, the terms device, IoT device, and tag may be used interchangeably to indicate an IOT device that is being inventoried/queried by the reader. The term reader may refer to the entity which queries the AIOT device. The term reader may refer to a network node or a WTRU, depending on the context and/or the topology. The embodiments disclosed here as applicable to IoT devices may also be used by other wireless devices such as WTRUs.

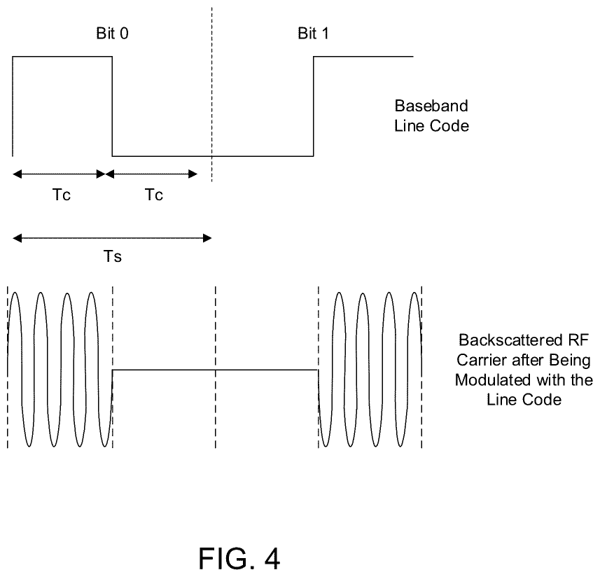

FIG. 4 shows the concept of backscatter modulation and some related terminology. Using a line encoding scheme, bit 0 is encoded as a pulse of amplitude 1 followed by a pulse of amplitude 0, and bit 1 is encoded as a pulse of amplitude 0 followed by a pulse of amplitude 1, where a line code is known as Manchester encoding. The bit (or symbol) duration is denoted as Ts. A chip may be defined as the smallest unit of pulse and the amplitude of a chip is assumed to be constant over the chip duration Tc. A symbol may comprise of one or more chips, for example in FIG. 4, each Manchester symbol is comprised of two chips.

The baseband line code modulates a received RF sinusoidal carrier. In this example, the amplitude of the backscattered signal is changed depending on the value of the line code chip. For example, when a baseband chip has value 1, the received RF carrier is reflected as it is during the duration of Tc. When a baseband chip has value 0, the received RF carrier is absorbed by the device, and nothing is backscattered.

In this disclosure, inventory may refer to the overall procedure of a reader triggering access by multiple devices using a sequence of messages (e.g., similar to query, followed by query rep in RFID). For example, the inventory procedure may refer to a single round of attempts to have each device respond or attempt to respond with its access ID or perform a random access channel (RACH) procedure. For example, the inventory procedure may refer to a set of access occasions which may have zero or at least one device respond within the access occasion.

In this disclosure, occasion may refer to the opportunity for device transmission that may be delimited by the transmission of a query rep message (or similar). For example, a device may perform transmission in an occasion by performing a AIOT transmission in a defined time following the query rep associated with that transmission. Alternatively, an occasion may comprise both a time aspect and a frequency aspect. For example, a device may determine an occasion as a transmission following a specific query rep, and by transmitting on one of a number of frequencies (e.g., FDM). Wherever embodiments indicate selection of an occasion, it may apply equivalently to selection of only a time component and/or selection of a frequency component.

Herein, depending on the embodiment or description, a reference to time may be associated with an absolute time measurement (e.g., seconds, slots, frames, and so forth). Alternatively, a reference to time may refer to a number of executions of a procedure, possibly triggered by a reader (e.g., number of inventory procedures, number of accesses or RACH procedures). Alternatively, a reference to time may refer to a number of messages, possibly of a specific type, or comprising specific information, as described herein, received or transmitted.

Configuration or pre-configuration may refer to a configuration received in/by a message (e.g., a radio resource control (RRC) message, a MAC control element (CE), a physical (PHY) layer signal, a data protocol data unit (PDU), or a control PDU associated with any or a new protocol layer) received from a network node or from another device or WTRU.

A device herein may be configured by the reader. The reader may be a network node or a WTRU. In the case of a WTRU, the WTRU may derive the device configuration itself or receive the device configuration from the network, in which case, the device configuration is being relayed from the network to the device by the WTRU. Aa WTRU configuration may be received from a network node (e.g., the gNB).

In an embodiment, a device may perform SFO estimation for Msg1 transmission.

A reader may transmit configuration of a monitoring interval or measurement window. In an embodiment, the reader may transmit a R2D message. The message may be a control message or a configuration message. The message may comprise a resource allocation for a measurement signal. The resource allocation may include one or more information.

The resource allocation may include information or an indication of a monitoring interval/window duration (i.e., a time interval during which a device may be expected to monitor a signal and/or a message). The resource allocation may include a duration for the monitoring interval and/or a starting time instance. The starting time instance may indicate to a device a point in time when the device may be expected to start the monitoring interval. The starting time instance may be determined with a reference to another point in time.

The resource allocation may include a gap duration. The interval between the reference point in time and the starting point in time of the monitoring interval may be equal to the indicated gap duration.

The time interval(s) indicated by the reader may be in terms of absolute time (e.g., seconds), a R2D chip, a D2R chip, a sample duration as determined by the reader or a device, in terms of another reference duration. For example, a time interval may be indicated as a function of a R2D transmission chip duration. The duration of a R2D chip may be indicated as Tc seconds. The gap may be indicated as N (corresponding to N×Tc seconds) and the monitoring window duration may be indicated as M (corresponding to M×Tc seconds).

The actual duration of a chip (e.g., as transmitted by the reader) and the duration of a chip measured by a device may be different and the device may be expected to use the measured duration. The difference may be due to SFO of the device, rounding errors, and other factors. For example, assume a sampling frequency of 2 MHz at the device, resulting in a sampling period of (½ MHz=0.5 μs). Let the actual chip duration as transmitted by the reader be 4 μs (i.e., 8 samples). In an example, a first device may measure the duration of the chip as k samples (k≠8). For example, the first device may measure the chip duration incorrectly as 3 μs (corresponding to 6 samples) while a second device may measure the chip duration correctly as 4 μs (i.e., 8 samples).

The reader may transmit a measurement signal and/or a measurement message (or a sequence or plurality of measurement signals or measurement messages) within the indicated monitoring interval. The totality or part of the measurement signal may be transmitted in the monitoring interval. The measurement signal may comprise one or more of the following.

The measurement signal may comprise a sequence, for example a preamble. The sequence may be known by the devices (e.g., by (pre)configuration or specification). For example, the preamble may be a square wave (e.g., modulated with OOK modulation).

The measurement signal may comprise one or a plurality of messages. A message may comprise at least one bit. In an example, the reader may transmit a plurality of messages with gaps between consecutive messages.

The device may determine, for example from a R2D transmission, one or more of the following. The device may determine the indicated gap duration, the starting point in time of the monitoring window, the monitoring window duration, and the reference point in time from which the gap duration is measured. For example, the reference point in time may be the end of a R2D transmission.

The device may start monitoring a measurement signal and/or message for a duration of the monitoring interval. Since a device may make errors in time measurement, a device may start monitoring before or after the actual time when the monitoring interval starts as indicated by the reader. Similarly, a device may perform monitoring for a longer or shorter duration than the actual duration as indicated by the reader.

The device may perform a measurement from the measurement signal and/or the message. The measurement may comprise one or more of the following.

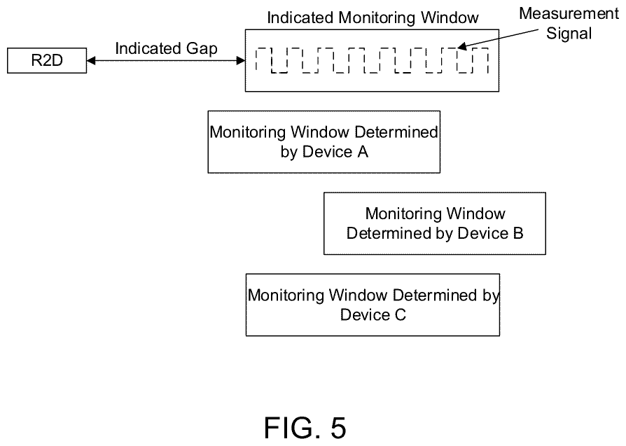

The measurement may comprise the number of chips of a measurement signal detected/received. For example, a reader may transmit a measurement signal of k chips and a device may measure k chips or fewer than k chips. FIG. 5 shows an example of devices monitoring a measurement signal of a reader to device (R2D) transmission. In this example, device A and device B monitor a R2D transmission within an interval that is different than the actual interval as indicated by the reader. Therefore, device A and device B measure a fewer number of chips of the measurement signal. Device C, on the other hand, monitors the R2D transmission within an interval that is same as the actual interval as indicated by the reader so device C measures a correct number of chips.

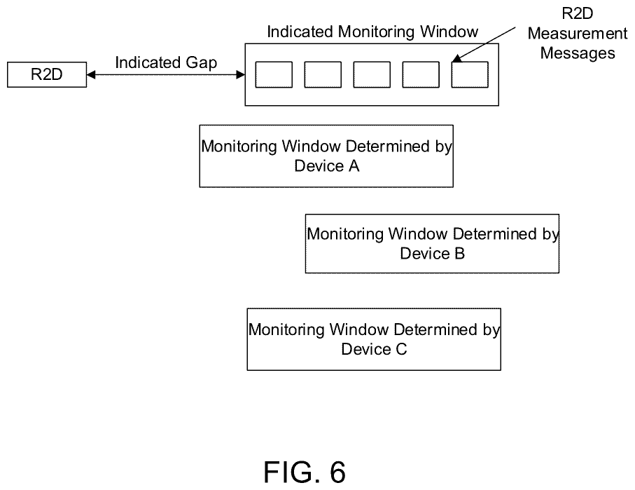

The measurement may comprise the number of rising and/or falling edges of the measurement signal detected/received. A device that monitors R2D transmission within an interval that is different than the actual interval may measure a fewer number of rising/falling edges of the measurement signal. The measurement may comprise the power of the measurement signal (e.g. received signal power). The measurement may comprise the energy of the measurement signal (e.g. received signal energy). The measurement may comprise the duration of the measurement signal. The duration may be in terms of, for example, samples, chips, rising and/or falling edges, or absolute time. The measurement may comprise a number of messages detected/received. FIG. 6 shows an example of devices monitoring measurement messages of a reader to device (R2D) transmission. In this example, device A and device B monitor R2D transmission within an interval that is different than the actual interval, so they detect a fewer number of messages while device C monitors R2D transmission within an interval that is same as the actual interval so device C detects a correct number of messages.

The reader may select or determine at least one device based on the measurement result. The selection or determination may be implicit. For example, the reader may send a message (i.e. select message) to select a subset of devices. The select message may be included in another message such as a paging message or the select message may be a separate message. In the select message, the reader may indicate a value or a range of values of a measurement a device may have performed. For example, assume the measurement is the number of chips detected in the monitoring window. If the reader sends, in the select message, a measurement value of “k”, this may indicate to the devices that devices that have measured “k” chips within the indicated monitoring interval are selected (e.g., these devices are allowed to transmit/receive within the resources associated with the select message). The type of the measurement to perform may be configured by the reader (e.g., using a control message and/or may be specified or (pre)configured).

The reader may send a value of a range of values for a measurement in a R2D transmission, and devices whose measurement results match the indicated value or falls in the indicated range may transmit/receive in the resources associated with the R2D transmission (i.e. be selected devices). For example, the R2D transmission may be a paging message, a Query message, a QueryRep message, or a RACH trigger message. For example, if the R2D transmission is a paging message, the associated resources may be time and/or frequency resources allocated to an inventory round. If the if the R2D transmission is a QueryRep message, the associated resources may be time and/or frequency resources allocated to a slot.

The indicated value or range of values may be associated with one or more of the following: a number of chips determined by a device (e.g., within a monitoring interval), a number of falling and/or rising edges determined by a device (e.g., within a monitoring interval), a received power (e.g., within a monitoring interval), a received energy (e.g., within a monitoring interval), and/or a number of messages detected/received (e.g., within a monitoring interval).

A reader may determine scheduling parameters based on the measurement parameters (e.g. the range reader is assuming). The reader may determine at least one scheduling parameter based on the value of a measurement wherein the scheduling parameter may be a parameter used by the reader and/or a device for transmission and/or reception.

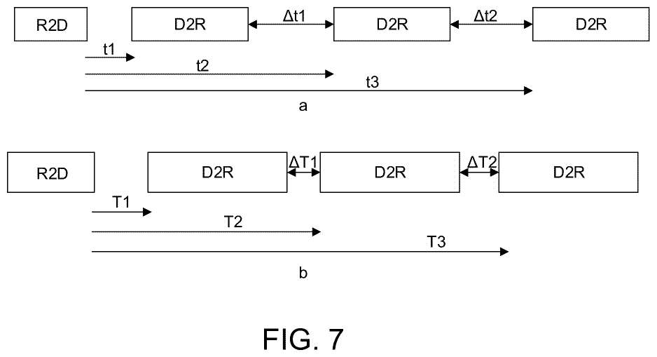

The scheduling parameters may comprise a time resource for a device, for example, the starting time of a D2R transmission (e.g., as a response to a R2D transmission). An example is shown in FIG. 7 where the reader schedules three D2R transmission resources as a response to a R2D transmission. For example, the R2D transmission may be a Msg2 transmission and the D2R transmission may be Msg3 transmission. In another example, the R2D transmission may be a RACH trigger message (e.g., paging, Query, or QueryRep) and the D2R transmission may be Msg1 transmission. Each resource may be used by separate devices.

In an example, as shown in FIG. 7a, the reader may select a first subset of devices with a first measurement value (e.g., for a first inventory round). For the first subset of devices, the reader may determine a first set of D2R time domain resources (e.g., at least one of starting time of a resource t1, t2, t3 and gaps between resources Δt1, Δt2) and indicate the resources to the devices (e.g., in a control message, and/or the R2D message).

In an example, as shown in FIG. 7b, the reader may select a second subset of devices with a second measurement value (e.g., for a second inventory round). For the second subset of devices, the reader may determine a second set of D2R time domain resources (e.g., at least one of starting time of a resource T1, T2, T3 and gaps between resources ΔT1, ΔT2) and indicate the resources to the devices (e.g., in a control message and/or the R2D message). For example, the first subset of devices may have higher SFO, resulting in less accurate measurement, and the second set of devices may have better SFO, resulting in more accurate measurement.

The resources may comprise a frequency resource parameter for a device, for example, the backscatter link frequency of a device.

The resources may comprise a chip duration of a D2R transmission. The chip duration may determine the frequency resource occupied by the D2R transmission.

The resources may comprise a chip repetition factor, for example, the number of repetitions within a bit duration of a line coded codeword.

In an embodiment, a measurement value or a range of values and the corresponding scheduling parameters may be configured and/or indicated by the reader. If a device is selected based on a measurement value, then the device may determine the scheduling parameters from the configuration.

A reader may be configured by the network. The reader may be a WTRU. The reader may receive configuration information in, for example, an RRC message and/or a MAC CE, from a gNB and/or indicated (e.g., signaled in a downlink control channel). The configuration information may include the measurement interval parameters such as interval duration and/or gap value. The configuration information may include a measurement signal/message type and associated parameters (e.g., chips, chip duration, rising/falling edges, number of measurement messages, and measurement message length in terms of bits). The configuration information may include a measurement signal transmit power. The configuration information may include scheduling parameters associated with a measurement value or a measurement gap. The configuration information may include time and/or frequency resources for transmitting the measurement signal/message (e.g., periodicity). For a configuration parameter (e.g. monitoring interval duration, chip duration), the network may configure multiple values via RRC and indicate one specific value with L1 control signaling and/or a MAC CE.

A device may perform a measurement and indicate the measurement result to the reader, for example in Msg1. For example, a device may measure the number of detected chips within a monitoring interval and indicate the measured value (the number of detected chips) in Msg1.

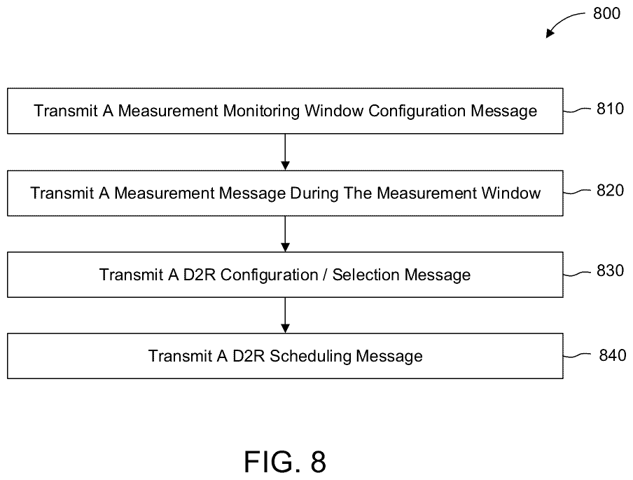

FIG. 8 shows an example method 800 for use in a reader. The reader may be a network entity (e.g. bNB) or a WTRU. The reader may be an AIoT reader. The reader may transmit an R2D message 810. The R2D message may be a control message or a configuration message that indicates configuration of a measurement monitoring interval or window. The reader may transmit the R2D message to one or more devices (e.g. AIoT devices). The R2D message may comprise resource allocation information for a measurement signal or message. The R2D message may comprise one or more indications of a monitoring interval or window. The monitoring interval may be a time interval during which a device may be expected to monitor one or more messages and/or signals. The monitoring interval indications may comprise a duration (e.g. time duration), a starting time instance, and/or a gap duration.

The reader may transmit a measurement signal or message 820. The reader may transmit a plurality (e.g. sequence) of measurement signals or messages. The reader may transmit the measurement signal or message during the monitoring interval. For example, the reader may transmit k messages in k resources in the monitoring interval and/or may transmit a signal comprising n chips in the monitoring interval. The totality of the measurement signal may be transmitted in the monitoring interval. Part of the measurement signal may be transmitted in the monitoring interval. The measurement signal may comprise a sequence (e.g. a preamble) and/or one or more message that may comprise at least one bit. The message may be transmitted with a gap between the messages.

The reader may transmit a D2R configuration (selection) message 830. The D2R configuration message may comprise a measurement parameter. The D2R configuration message (measurement parameter) may comprise information for device selection (e.g. subset of devices) based on a measurement result or a range of measurement results The D2R configuration message may be (or be a part of) a paging message. At least one parameter of the D2R configuration message may be associated with a parameter (e.g. k messages or n chips) of the measurement message or signal transmitted during the monitoring interval. For example, the parameter may be an integer between 1-to-k or 1-to-n and devices that have measured the number of messages/chips indicated with the parameter may join the associated inventory round (e.g. be a selected device). For example, the D2R configuration message may comprise a value or a range of values for a measurement in a R2D transmission, and devices whose measurement results match the indicated value or falls in the indicated range may be allowed to transmit/receive in the resources associated with the R2D transmission. The indicated value or range of values may be associated with one or more of the following: a number of chips determined by a device, a number of falling and/or rising edges determined by a device, a received power, a received energy, and/or a number of messages detected/received during the monitoring interval. The reader may select a subset of devices (e.g. for an inventory round) based on the measurement parameter in the D2R configuration message. The reader may determine the at least one measurement parameter based on a sampling frequency offset (SFO). For example, the reader may select parameters for (associated with or corresponding to) devices having a small (smallest) SFO in a first round. The reader may select parameters for (associated with or corresponding to) devices having a next smallest SFO in a next round and so on.

The reader may transmit a D2R scheduling message 840. The reader may determine one or more scheduling parameters based on a measurement parameter. The scheduling message may comprise the scheduling parameter(s). The scheduling parameter may be used by the reader and a device for transmission and reception. The scheduling parameter may be a time resource for a device or an index to a time resource. For example, the scheduling parameter may comprise a starting time for a D2R transmission, for example as a response to a R2D transmission (e.g. t1, t2, t3 in FIG. 7a and T1, T2, T3 in FIG. 7b). For example, the scheduling parameter may comprise a gap between resources (e.g. Δt1, Δt2, Δt3 in FIG. 7a and ΔT1, ΔT2, ΔT3 in FIG. 7b). The scheduling parameter may comprise a frequency resource parameter for a device or an index to a frequency resource. The scheduling parameter may comprise a chip duration of a D2R transmission or an index to a chip duration. The scheduling parameter may comprise a chip repetition factor or an index to a chip repetition factor. The scheduling parameter(s) may be configured and/or indicated in a first message and the scheduling message may comprise a first index to a first scheduling parameter, a second index to a second scheduling parameter, and so forth. The scheduling message may comprise an index to a group of scheduling parameters.

The reader may receive a D2R transmission from a device based on the scheduling parameters.

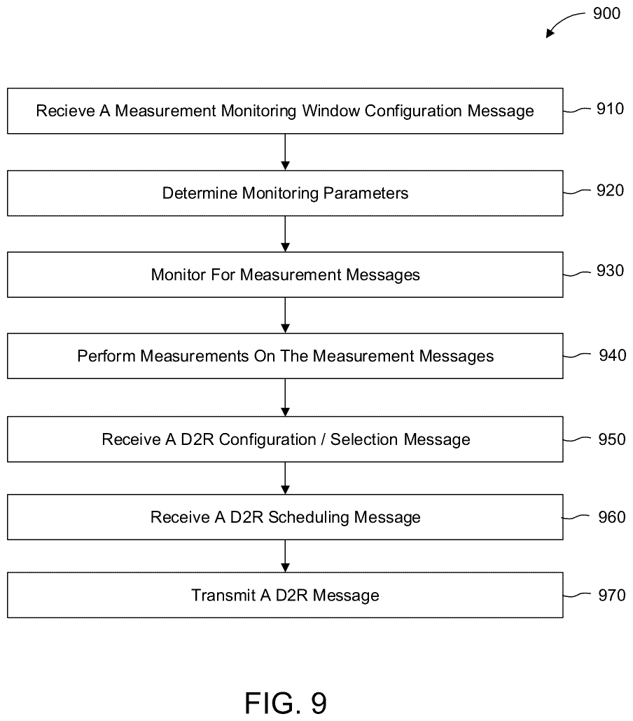

FIG. 9 shows an example method 900 for use in a device (e.g. AIoT device). The device may receive a measurement monitoring window configuration message 910 from a reader. The message may be a control message or a configuration message that indicates configuration of a measurement monitoring interval or window. The message may comprise resource allocation information for a measurement signal or message. The message may comprise one or more indications of a monitoring interval or window. The monitoring interval may be a time interval during which the device may be expected to monitor one or more messages and/or signals. The monitoring interval indications may comprise a duration (e.g. time duration), a starting time instance, and/or a gap duration.

The device may determine, from the measurement monitoring window configuration message, one or more monitoring parameters 920, for example: indicated gap duration, the starting point in time of the monitoring window, the monitoring window duration, the reference point in time from which the gap duration is measured. For example, the reference point may be the end of a R2D transmission.

The device may monitor for (and receive) a measurement signal or message 930. The device may receive a plurality (e.g. sequence) of measurement signals or messages. The device may receive the measurement signal or message during the monitoring interval. Since the device may make errors in time measurement, the device may start monitoring before or after the actual time when the monitoring interval starts, as indicated by the reader. Similarly, a device may perform monitoring for a longer or shorter duration than the actual duration as indicated by the reader.

The device may perform measurements on the signal(s) or message(s) 940. The measurement may comprise the number of chips of a measurement signal detected/received. For example, a reader may transmit a measurement signal of k chips and a device may measure k chips or fewer than k chips. For example, as shown in FIG. 5, device A and device B monitor a R2D transmission within an interval that is different than the actual interval as indicated by the reader. Therefore, device A and device B measure a fewer number of chips of the measurement signal. Device C, on the other hand, monitors the R2D transmission within an interval that is same as the actual interval as indicated by the reader so device C measures a correct number of chips. The measurement may comprise the number of rising and/or falling edges of the measurement signal detected/received. A device that monitors R2D transmission within an interval that is different than the actual interval may measure a fewer number of rising/falling edges of the measurement signal. The measurement may comprise the power of the measurement signal (e.g. received signal power). The measurement may comprise the energy of the measurement signal (e.g. received signal energy). The measurement may comprise the duration of the measurement signal. The duration may be in terms of, for example, samples, chips, rising and/or falling edges, or absolute time. The measurement may comprise a number of messages detected/received. For example, as shown in FIG. 6, device A and device B monitor R2D transmission within an interval that is different than the actual interval, so they detect a fewer number of messages while device C monitors R2D transmission within an interval that is same as the actual interval so device C detects a correct number of messages

For example, the reader may transmit k messages in k resources in the monitoring interval and/or may transmit a signal comprising n chips in the monitoring interval. The totality of the measurement signal may be transmitted in the monitoring interval. Part of the measurement signal may be transmitted in the monitoring interval. The measurement signal may comprise a sequence (e.g. a preamble) and/or one or more message that may comprise at least one bit. The message may be transmitted with a gap between the messages.

The device may receive a D2R configuration (selection) message 950. The D2R configuration message may comprise a measurement parameter. The D2R configuration message (measurement parameter) may comprise information for device selection (e.g. subset of devices) based on a measurement result or a range of measurement results The D2R configuration message may be (or be a part of) a paging message. At least one parameter of the D2R configuration message may be associated with a parameter (e.g. k messages or n chips) of the measurement message or signal transmitted during the monitoring interval. For example, the parameter may be an integer between 1-to-k or 1-to-n and if the device has measured the number of messages/chips indicated with the parameter, the device may join the associated inventory round (e.g. be a selected device). For example, the D2R configuration message may comprise a value or a range of values for a measurement in a R2D transmission, and if the device's measurement results matches the indicated value or falls in the indicated range, the device may be allowed to transmit/receive in the resources associated with the R2D transmission. The indicated value or range of values may be associated with one or more of the following: a number of chips determined by a device, a number of falling and/or rising edges determined by a device, a received power, a received energy, and/or a number of messages detected/received during the monitoring interval. The reader may select a subset of devices (e.g. for an inventory round) based on the measurement parameter in the D2R configuration message.

The device may receive a D2R scheduling message 960. The one or more scheduling parameters may be based on a measurement parameter. The scheduling message may comprise the scheduling parameter(s). The scheduling parameter may be used by the reader and a device for transmission and reception. The scheduling parameter may be a time resource for a device. For example, the scheduling parameter may comprise a starting time for a D2R transmission, for example as a response to a R2D transmission (e.g. t1, t2, t3 in FIG. 7a and T1, T2, T3 in FIG. 7b). For example, the scheduling parameter may comprise a gap between resources (e.g. Δt1, Δt2, Δt3 in FIG. 7a and ΔT1, ΔT2, ΔT3 in FIG. 7b). The scheduling parameter may comprise a frequency resource parameter for a device. The scheduling parameter may comprise a chip duration of a D2R transmission. The scheduling parameter may comprise a chip repetition factor. The reader may receive a D2R transmission from a device based on the scheduling parameters.

The device may transmit based on the resources in the D2R scheduling message 970.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method implemented by an ambient Internet of Things (AIoT) reader, the method comprising:
transmitting measurement monitoring window configuration information, wherein the measurement monitoring window configuration information comprises an indication of a time duration and a gap duration;
transmitting at least one measurement message during the measurement monitoring window;
transmitting a device to reader (D2R) configuration message, wherein the D2R configuration message comprises at least one measurement parameter; and
transmitting a D2R scheduling message, wherein the D2R scheduling message comprises at least one scheduling parameter based on the at least one measurement parameter.

2. The method of claim 1, wherein the measurement monitoring window configuration information comprises an indication of a start time of the measurement monitoring window.

3. The method of claim 1, further comprising:
determining the at least one measurement parameter based on a sampling frequency offset (SFO).

4. The method of claim 1, wherein the at least one measurement parameter is associated with a parameter of the at least one measurement message.

5. The method of claim 4, wherein the parameter of the at least one measurement message is a number of measurement messages transmitted during the measurement monitoring window.

6. The method of claim 1, wherein the at least one measurement parameter indicates a value or a range of values.

7. The method of claim 1, wherein the at least one measurement parameter comprises at least one of: a number of chips of a measurement signal, a number of falling and/or rising edges of a measurement signal, a received power, a received energy, or a number of messages detected during the measurement monitoring window.

8. The method of claim 1, wherein the at least one scheduling parameter comprises a starting time of a D2R transmission and a time gap between an ending time of a first D2R transmission and a starting time of a second D2R transmission.

9. The method of claim 1, wherein the at least one measurement message comprises a signal comprising a plurality of chips.

10. The method of claim 1, wherein the AIoT reader is a wireless transmit/receive unit (WTRU) or a gNB, and wherein the AIoT reader communicates with an AIoT device.

11. An ambient Internet of Things (AIoT) reader configured to:
transmit measurement monitoring window configuration information, wherein the measurement monitoring window configuration information comprises an indication of a time duration and a gap duration;
transmit at least one measurement message during a measurement monitoring window;
transmit a device to reader (D2R) configuration message, wherein the D2R configuration message comprises at least one measurement parameter; and
transmit a D2R scheduling message, wherein the D2R scheduling message comprises at least one scheduling parameter based on the at least one measurement parameter.

12. The AIoT reader of claim 11, wherein the measurement monitoring window configuration information comprises an indication of a start time of the measurement monitoring window.

13. The AIoT reader of claim 11, wherein the AIoT reader is configured to determine the at least one measurement parameter based on a sampling frequency offset (SFO).

14. The AIoT reader of claim 11, wherein the at least one measurement parameter is associated with a parameter of the at least one measurement message.

15. The AIoT reader of claim 14, wherein the parameter of the at least one measurement message is a number of measurement messages transmitted during the measurement monitoring window.

16. The AIoT reader of claim 11, wherein the at least one measurement parameter indicates a value or a range of values.

17. The AIoT reader of claim 11, wherein the at least one measurement parameter comprises at least one of: a number of chips of a measurement signal, a number of falling and/or rising edges of a measurement signal, a received power, a received energy, or a number of messages detected during the measurement monitoring window.

18. The AIoT reader of claim 11, wherein the at least one scheduling parameter comprises a starting time of a D2R transmission and a time gap between an ending time of a first D2R transmission and a starting time of a second D2R transmission.

19. The AIoT reader of claim 11, wherein the at least one measurement message comprises a signal comprising a plurality of chips.

20. The AIoT reader of claim 11, wherein the AIoT reader is a wireless transmit/receive unit (WTRU) or a gNB, and wherein the AIoT reader is configured to communicate with an AIoT device.
